(19) United States
(12) Patent Application Publication
(10) Pub. No.: US 2025/0149867 A1
(43) Pub. Date: May 8, 2025

(54) VACUUM CHAMBER SEAL

(71) Applicant: FIRST LIGHT FUSION LIMITED, Yarnton Oxfordshire (GB)

(72) Inventors: Paul Holligan, Yarnton Oxfordshire (GB); James Parkin, Yarnton Oxfordshire (GB); Jamie Darling, Yarnton Oxfordshire (GB); Luis Caballero Bendixsen, Yarnton Oxfordshire (GB); Oliver Hall, Yarnton Oxfordshire (GB)

(21) Appl. No.: 19/020,646

(22) Filed: Jan. 14, 2025

Related U.S. Application Data
(63) Continuation of application No. 17/794,502, filed on Jul. 21, 2022.

(30) Foreign Application Priority Data
Jan. 24, 2020 (GB) 2001054.2

(51) Int. Cl. H02B 1/28; F16J 15/02

(52) U.S. Cl. CPC H02B 1/28; F16J 15/022

(57) ABSTRACT

A seal for a vacuum chamber is formed from two outer insulation blocks, an intermediate insulation block, some interior insulation sheets and some exterior insulation sheets. A first outer insulation block seals between a first wall of the vacuum chamber and a first power transmission plate A second outer insulation block seals between a second wall of the vacuum chamber and a second power transmission plate. The intermediate insulation block seals between the first and second power transmission plates. The interior insulation sheets are arranged in slots in a first side of the intermediate insulation block. The exterior insulation sheets are arranged in the slots in a second side of the intermediate insulation block.

### CROSS-REFERENCE TO RELATED APPLICATIONS

This application is a continuation of U.S. patent application Ser. No. 17/794,502 filed on Jul. 21, 2022, which is the 35 U.S.C. § 371 national phase of International Application No. PCT/GB2021/050144, filed on Jan. 22, 2021, and claims the benefit of United Kingdom Patent Application No. 2001054.2 filed on Jan. 24, 2020, wherein the entire contents of the foregoing applications are hereby incorporated by reference herein.

### BACKGROUND

A number of different applications require a high voltage power supply to be fed into a vacuum chamber, for delivering to a load in the vacuum chamber, e.g. via a pair of power transmission plates. In order to maintain an effective vacuum in the vacuum chamber, a good seal around where the power supply enters the vacuum chamber needs to be provided. An effective vacuum helps to reduce the risk of electrical breakdown in the vacuum chamber. The seal also provides insulation between the power supply and the walls of the vacuum chamber, and between the power transmission plates of the high voltage supply. Such insulation also helps to reduce the risk of electrical breakdown, e.g. in the form of surface tracking, between the power transmission plates of the high voltage supply.

The presence of insulation, however, creates an inductance in the high voltage power supply, e.g. between the power transmission plates. For particular applications, for example when a fast discharge of the high voltage power supply to a load in the vacuum chamber is required, it may be beneficial to reduce the inductance as much as possible. However, if the inductance is to be reduced, this generally means that the (e.g. thickness of the) insulation has to be reduced, such that the risk of electrical breakdown may increase, particularly when high voltages are being used.

### SUMMARY

The present invention aims to provide an improved seal for a pair of power transmission plates that extend through the wall of a vacuum chamber.

When viewed from a first aspect the invention provides a seal for a vacuum chamber, wherein the vacuum chamber comprises a first wall and a second wall, the seal comprising:
a first outer insulation block for sealing between the first wall of the vacuum chamber and a first power transmission plate that extends from the interior of the vacuum chamber to the exterior of the vacuum chamber between the first and second walls of the vacuum chamber;
a second outer insulation block for sealing between the second wall of the vacuum chamber and a second power transmission plate that extends from the interior of the vacuum chamber to the exterior of the vacuum chamber between the first and second walls of the vacuum chamber;
an intermediate insulation block for sealing between the first and second power transmission plates, wherein the intermediate insulation block comprises one or more slots formed in a first side of the intermediate insulation block for facing the interior of the vacuum chamber and one or more slots formed in a second side of the intermediate insulation block for facing the exterior of the vacuum chamber;
one or more interior insulation sheets for extending between the first and second power transmission plates on the interior of the vacuum chamber, wherein the one or more interior insulation sheets are arranged in the one or more slots in the first side of the intermediate insulation block; and
one or more exterior insulation sheets for extending between the first and second power transmission plates on the exterior of the vacuum chamber, wherein the one or more exterior insulation sheets are arranged in the one or more slots in the second side of the intermediate insulation block.

The present invention provides a vacuum chamber seal, for sealing between the walls of (e.g. two halves of) a vacuum chamber and a pair of electric power transmission plates that extend through the vacuum chamber walls. The seal is made up of three insulation blocks that interleave the two vacuum chamber walls and the pair of power transmission plates. The insulation blocks, when installed in the vacuum chamber, are arranged such that there is a (first outer) insulation block between one of the vacuum chamber walls and one of the power transmission plates, another (second outer) insulation block between the other of the vacuum chamber walls and the other of the power transmission plates, and the final (intermediate) insulation block between the pair of power transmission plates. Thus, each insulation block is arranged for sealing against the vacuum chamber walls and the power transmission plates, as appropriate. It will be seen that when the seal is assembled, the intermediate insulation block is positioned between the first and second outer insulation blocks, which lie at the outer edges of the seal.

The intermediate insulation block has one or more slots formed in either side of the insulation block. On a first side of the intermediate insulation block, for facing the interior of the vacuum chamber, one or more interior insulation sheets are located in the slot(s) on this side of the intermediate insulation block. On a second side of the intermediate insulation block, for facing the exterior of the vacuum chamber, one or more exterior insulation sheets are located in the slot(s) on this side of the intermediate insulation block. Thus, insulation sheet(s) extend from the slots on either side of the intermediate insulation block. The insulation sheet(s) are provided for extending between the pair of power transmission plates on both the interior and exterior of the vacuum chamber.

Thus it will be appreciated that by providing a seal that includes insulation blocks for positioning between the walls of the vacuum and the pair of power transmission plates, an effective seal between the walls of the vacuum and the pair of power transmission plates may be provided, owing to the (e.g. substantial and solid) nature of the insulation blocks, which helps to enable a good vacuum to be established in the vacuum chamber. The insulation sheet(s) of the seal, for extending between the pair of power transmission plates (e.g. away from the walls of the vacuum chamber) help to allow the pair of power transmission plates to be brought closer together (e.g. than when they pass through the insulation blocks), thus helping to reduce the inductance between the pair of power transmission plates, while still providing sufficient insulation between them (e.g. to protect against electrical punch through, even when subject to a high electric field gradient).

It will be also appreciated that while the insulation sheets may provide good insulation between the pair of power transmission plates, the insulation sheets are less suitable for forming a seal directly between the walls of the vacuum chamber and the pair of power transmission plates; this is better provided by the insulation blocks. Thus, the seal of the present invention exploits the beneficial properties of both the insulation blocks (i.e. a good seal) and the insulation sheets (i.e. providing a high dielectric strength barrier, helping to enable low inductance).

A transition between the insulation sheet(s) and insulation blocks of the seal is provided by arranging the insulation sheet(s) in the slot(s) on either of the intermediate insulation block. This helps to reduce the extent of the insulation blocks (e.g. confining them to the vicinity of the walls of the vacuum chamber), which helps to reduce the inductance between the pair of power transmission plates, while still allowing a good seal to be provided and insulating the power transmission plates from each other (and, e.g., from the walls of the vacuum chamber). This helps to allow the power transmission plates to deliver a high voltage and current into the (e.g. load in the) vacuum chamber, e.g. at a high discharge rate.

The slots in the intermediate insulation block also help to increase the path length between the power transmission plates. This helps to reduce the risk of electrical breakdown owing to surface tracking. Arranging the insulation sheets in the slots may also allow the insulation sheets to be replaced, when required, thus helping to provide a seal that is easy to maintain.

The seal of the present invention therefore helps to provide a good seal for a vacuum chamber where a pair of high voltage power transmission plates is required to be fed into the vacuum chamber. The seal helps to provide low inductance between the power transmission plates while providing good insulation and a good vacuum seal. This may allow the power transmission plates to deliver a high voltage and current to (e.g. a load in) the vacuum chamber that can be discharged quickly, while reducing the risk of electrical breakdown (e.g. while the power transmission plates are being discharged).

The vacuum chamber may be any suitable and desired type of vacuum chamber, with the first and second walls provided in any suitable and desired configuration. In a preferred embodiment the vacuum chamber comprises a load, wherein the first and second power transmission plates are arranged to deliver a voltage (and current) to the load. The invention extends to a vacuum chamber per se and therefore when viewed from a further aspect the invention provides a vacuum chamber comprising:
a first wall and a second wall defining the outer surface of the vacuum chamber;
a load within the vacuum chamber;
a first power transmission plate that extends from the interior of the vacuum chamber to the exterior of the vacuum chamber between the first and second walls of the vacuum chamber;
a second power transmission plate that extends from the interior of the vacuum chamber to the exterior of the vacuum chamber between the first and second walls of the vacuum chamber, wherein the first and second power transmission plates are arranged to deliver a voltage to the load; and
a seal for sealing between the first and second walls, and between the first and second power transmission plates;
wherein the seal comprises:
   a first outer insulation block sealing between the first wall of the vacuum chamber and the first power transmission plate;
   a second outer insulation block sealing between the second wall of the vacuum chamber and the second power transmission plate;
   an intermediate insulation block sealing between the first and second power transmission plates, wherein the intermediate insulation block comprises one or more slots formed in a first side of the intermediate insulation block facing the interior of the vacuum chamber and one or more slots formed in a second side of the intermediate insulation block facing the exterior of the vacuum chamber;
   one or more interior insulation sheets extending between the first and second power transmission plates on the interior of the vacuum chamber, wherein the one or more interior insulation sheets are arranged in the one or more slots in the first side of the intermediate insulation block; and
   one or more exterior insulation sheets extending between the first and second power transmission plates on the exterior of the vacuum chamber, wherein the one or more exterior insulation sheets are arranged in the one or more slots in the second side of the intermediate insulation block.

It will be appreciated that the subject matter of this aspect of the invention may (and preferably does) include one or more (e.g. all) of the optional and preferred features of the other aspects of the invention outlined herein.

The first and second walls may be arranged in any suitable and desired way, e.g. to form the vacuum chamber. Preferably the first and second walls comprise outer walls of the vacuum chamber. In one embodiment the vacuum chamber is substantially cylindrical, although the vacuum chamber may be any suitable and desired shape and size, e.g. depending on the intended use of the vacuum chamber. Thus, preferably the first wall and the second wall together define a cylindrical outer wall of the vacuum chamber. Preferably the first wall and/or the second wall are (each) substantially cylindrical.

It will thus be appreciated that preferably the first and second walls of the vacuum chamber (and their edges that are sealed together by the seal of the present invention) extend around (e.g. all of) the perimeter of the vacuum chamber. Thus, preferably the seal (and the components thereof, e.g. the insulation blocks and the insulation sheets) extends around (e.g. all of) the perimeter of the vacuum chamber. Thus, preferably the seal (and the components thereof) comprises an annulus extending around the perimeter of the vacuum chamber between the first and second walls of the vacuum chamber.

Preferably the first and second walls of the vacuum chamber are held (e.g. clamped) together around the seal. Preferably the (e.g. components of the) seal are held under compression. This helps to improve the effectiveness of the seal and thus the vacuum in the chamber, owing to the seal forming an effective barrier to the pressure differential formed across the walls of the vacuum chamber from the interior to the exterior of the vacuum chamber, and from the seal expelling air from the seal, e.g. to reduce the risk of electrical breakdown. Thus, preferably the first and second walls of the vacuum chamber are arranged to compress the (e.g. components of the) seal. Preferably the weight of the vacuum chamber is arranged to act on the first and second walls of the vacuum chamber to compress the seal. The evacuation of the vacuum chamber to form a vacuum also helps to pull the walls of the vacuum chamber together to compress the seal.

The (e.g. first and second walls of the) vacuum chamber may be made of any suitable and desired material. Preferably the first and second walls of the vacuum chamber are made of metal. This helps to provide strong walls of the vacuum chamber that are compatible with generating a vacuum.

The vacuum chamber (and the seal thereof) may be arranged to form a vacuum inside the vacuum chamber of any suitable and desired level. In one embodiment the vacuum chamber (and the seal thereof) is arranged to form a vacuum of less than 10-4 mbar. This helps to reduce the risk of electrical breakdown in the vacuum chamber.

The power transmission plates may be provided in any suitable and desired way. Preferably the power transmission plates are (each) substantially planar, particularly as they pass through the seal and the first and second walls of the vacuum chamber. Thus, preferably the power transmission plates (each) have a thickness that is substantially smaller than a length and/or a width of the power transmission plates.

The power transmission plates are preferably arranged to pass between the first and second walls of the vacuum chamber such that the thickness of the power transmission plates extends in a direction (e.g. parallel to the direction) between the first and second walls of the vacuum chamber. In other words, the power transmission plates are preferably arranged to pass between the first and second walls of the vacuum chamber such that the thickness of the power transmission plates extends in a direction (e.g. parallel to the direction) across the seal, i.e. parallel to the direction between the first and second outer insulation blocks through the intermediate insulation block.

The first and second power transmission plates may be made from any suitable and desired material. Preferably the first and second power transmission plates are (each) conductive, e.g. made of metal.

The first and second power transmission plates may be arranged to deliver any suitable and desired voltage and/or current to the (e.g. load in the) vacuum chamber. Preferably the first and second power transmission plates are arranged to deliver a (required) high voltage of at least 50 kV, e.g. at least 100 kV, e.g. approximately 200 kV, to the (e.g. load in the) vacuum chamber. The first and second power transmission plates could be arranged such that one of the plates is a ground plate and one of the plates is a positive (or negative) plate (e.g. a live plate). However, preferably the first and second power transmission plates are arranged such that one of the plates is held at a positive voltage and one of the plates is held at a (e.g. equal magnitude) negative voltage.

Preferably the first and second power transmission plates are arranged (e.g. when the voltage is discharged) to deliver a (e.g. high) current to the (e.g. load in the) vacuum chamber.

The invention also extends to an electric power feed apparatus and thus when viewed from a further aspect the invention provides an electric power feed apparatus for delivering a voltage to a load within a vacuum chamber, wherein the vacuum chamber comprises a first wall and a second wall, the electric power feed apparatus comprising:
a first power transmission plate for extending from the interior of the vacuum chamber to the exterior of the vacuum chamber between the first and second walls of the vacuum chamber;
a second power transmission plate for extending from the interior of the vacuum chamber to the exterior of the vacuum chamber between the first and second walls of the vacuum chamber, wherein the first and second power transmission plates are arranged to deliver a voltage to the load; and
a seal for sealing between the first and second walls, and between the first and second power transmission plates, wherein the seal comprises:
   a first outer insulation block for sealing between the first wall of the vacuum chamber and the first power transmission plate;
   a second outer insulation block for sealing between the second wall of the vacuum chamber and the second power transmission plate;
   an intermediate insulation block sealing between the first and second power transmission plates, wherein the intermediate insulation block comprises one or more slots formed in a first side of the intermediate insulation block for facing the interior of the vacuum chamber and one or more slots formed in a second side of the intermediate insulation block for facing the exterior of the vacuum chamber;
   one or more interior insulation sheets extending between the first and second power transmission plates on the interior of the vacuum chamber, wherein the one or more interior insulation sheets are arranged in the one or more slots in the first side of the intermediate insulation block; and
   one or more exterior insulation sheets extending between the first and second power transmission plates on the exterior of the vacuum chamber, wherein the one or more exterior insulation sheets are arranged in the one or more slots in the second side of the intermediate insulation block.

It will be appreciated that the subject matter of this aspect of the invention may (and preferably does) include one or more (e.g. all) of the optional and preferred features of the other aspects of the invention outlined herein.

Preferably the electric power feed apparatus comprises a voltage generation system for applying a voltage between the first and second power transmission plates. The electric power feed apparatus preferably comprises a mechanism for discharging the voltage on the first and second power transmission plates to the load in the vacuum chamber.

The vacuum chamber may be used for any suitable and desired use. In one embodiment the vacuum chamber is used as part of a pulsed power (e.g. high energy density physics) apparatus. The invention extends to a pulsed power (e.g. high energy density physics) apparatus and thus when viewed from a further aspect the invention provides a pulsed power (e.g. high energy density physics) apparatus comprising:
a vacuum chamber, the vacuum chamber comprising:
   a first wall and a second wall defining the outer surface of the vacuum chamber; and
   a load within the vacuum chamber;
the pulsed power apparatus further comprising:
   a first power transmission plate that extends from the interior of the vacuum chamber to the exterior of the vacuum chamber between the first and second walls of the vacuum chamber;
   a second power transmission plate that extends from the interior of the vacuum chamber to the exterior of the vacuum chamber between the first and second walls of the vacuum chamber, wherein the first and second power transmission plates are arranged to deliver a voltage to the load;
   a voltage generation system for applying a voltage between the first and second power transmission plates; and
   a seal for sealing between the first and second walls, and between the first and second power transmission plates;
   wherein the seal comprises:
      a first outer insulation block sealing between the first wall of the vacuum chamber and the first power transmission plate;
      a second outer insulation block sealing between the second wall of the vacuum chamber and the second power transmission plate;
      an intermediate insulation block sealing between the first and second power transmission plates, wherein the intermediate insulation block comprises one or more slots formed in a first side of the intermediate insulation block facing the interior of the vacuum chamber and one or more slots formed in a second side of the intermediate insulation block facing the exterior of the vacuum chamber;
      one or more interior insulation sheets extending between the first and second power transmission plates on the interior of the vacuum chamber, wherein the one or more interior insulation sheets are arranged in the one or more slots in the first side of the intermediate insulation block; and
      one or more exterior insulation sheets extending between the first and second power transmission plates on the exterior of the vacuum chamber, wherein the one or more exterior insulation sheets are arranged in the one or more slots in the second side of the intermediate insulation block.

It will be appreciated that the subject matter of this aspect of the invention may (and preferably does) include one or more (e.g. all) of the optional and preferred features of the other aspects of the invention outlined herein.

The voltage generation system preferably comprises one or more capacitors arranged to be charged for applying the voltage to the first and second power transmission plates. The pulsed power apparatus preferably comprises a mechanism for discharging the voltage on the first and second power transmission plates to the load in the vacuum chamber.

While the seal may be used for a vacuum chamber, e.g. as part of a pulsed power apparatus, the seal may alternatively be used for a different type of chamber in which a seal is required (e.g. a pressurised chamber and/or a chamber containing dielectric liquid or gas).

The first and second outer insulation blocks, and the intermediate insulation block, may be provided in any suitable and desired way, to seal against the walls of the vacuum chamber, and the power transmission plates. Preferably the first outer insulation block comprises mating surfaces for sealing against (and between) the first wall of the vacuum chamber and the first power transmission plate. Preferably the second outer insulation block comprises mating surfaces for sealing against (and between) the second wall of the vacuum chamber and the second power transmission plate. Preferably the intermediate insulation block comprises mating surfaces for sealing against (and between) the first and second power transmission plates.

The mating surfaces are preferably shaped to match the shape of the surfaces of the walls of the vacuum chamber, and the power transmission plates, against which they are sealing. Preferably the mating surfaces are (e.g. each) substantially planar. This helps to form a good seal between the insulation blocks and the walls of the vacuum chamber, and the power transmission plates.

In one embodiment the seal comprises a compressible (e.g. dielectric) material (e.g. layer) between the (e.g. mating surfaces of the) insulation blocks and the respective components they are sealing against. The compressible material helps to provide an air-tight seal between the components that the insulation blocks are sealing against, which may help to generate a better seal for the vacuum chamber and thus help to generate a more effective vacuum. The compressible material between the insulation blocks and the respective components they are sealing against also helps to reduce the risk of surface tracking across the insulation blocks from the interior to the exterior of the vacuum chamber (or vice versa) through the seal.

Preferably the compressible material is arranged to be compressed between the (e.g. mating surfaces of) the insulation blocks and the respective components they are sealing against, e.g. when the seal is put under compression.

The compressible material may be provided in any suitable and desired way. In one embodiment one or more (e.g. any combination or all of) the mating surfaces of (e.g. each of) the insulation blocks comprise one or more grooves, wherein the compressible material is arranged in (e.g. each of) the grooves. Preferably the compressible material comprises a gasket, e.g. a linear cord or an O-ring.

The mating surfaces of the insulation blocks may comprise any suitable number of grooves into which the compressible material is placed. In one embodiment (e.g. each) mating surface comprises only a single groove. Preferably the grooves in the mating surfaces are offset from each other. Thus, preferably the groove in a mating surface is offset from (e.g. closer to the interior or exterior of the vacuum chamber) the groove in an adjacent mating surface. For example, the groove in the mating surface of first outer insulation block that seals against the first power transmission plate is preferably offset from the groove in the mating surface of the intermediate insulation block that seals against the first power transmission plate.

The first and second outer insulation blocks, and the intermediate insulation block, may be made from any suitable and desired (dielectric) material. Preferably the first and second outer insulation blocks, and the intermediate insulation block, (e.g. each) comprise a solid (e.g. substantially incompressible, e.g. rigid) block. Preferably the first and second outer insulation blocks, and the intermediate insulation block, (e.g. each) comprise a (e.g. thermoplastic) polymer, e.g. high-density polyethylene (HDPE). Preferably the dielectric strength of (e.g. each of) the first and second outer insulation blocks, and the intermediate insulation block, is greater than 10 kV/mm, e.g. greater than 20 kV/mm, e.g. approximately 22 kV/mm.

The first and second outer insulation blocks, and the intermediate insulation block, may have any suitable and desired dimensions. For example, the dimensions of the insulation blocks may depend on one or more (e.g. all) of the dimensions of the walls of the vacuum chamber, the dimensions of the power transmission plates and the voltages carried by the power transmission plates. In one embodiment the dimension of (e.g. each of) the first and second outer insulation blocks, and the intermediate insulation block, in a (e.g. radial) direction across the walls of the vacuum chamber is greater than or equal to the dimension of the first and second walls of the vacuum chamber in a direction across the walls of the vacuum chamber.

In one embodiment the dimension (thickness) of the intermediate insulation block in a direction (e.g. parallel to the direction) between the first and second walls of the vacuum chamber is greater than the ratio of the voltage across the power transmission plates to the dielectric strength of the intermediate insulation block, e.g. at least twice the ratio of the voltage across the power transmission plates to the dielectric strength of the intermediate insulation block. Thus, in a particularly preferred embodiment, when the intermediate insulation block is made from HDPE (having a dielectric strength of 22 kV/mm) and the voltage across the pair of power transmission plates is 200 kV, the thickness of the intermediate insulation block is 18 mm (i.e. giving a safety factor of two).

The first and second outer insulation blocks may have any suitable and desired shape for being held against (e.g. attached to) the first and second walls of the vacuum chamber respectively. For example, the mating surface of the outer insulation blocks for sealing against the respective wall of the vacuum chamber may extend all the way across the outer insulation blocks. However, in a preferred embodiment, the first and second outer insulation blocks are shaped to extend up the sides of the first and second walls of the vacuum chamber respectively. Thus, preferably the first and second outer insulation blocks are U-shaped.

The slots in the sides of the intermediate insulation block for receiving the insulation sheets may be provided in any suitable and desired way. Preferably the slots are arranged such that the ends of multiple (e.g. sets of) insulation sheets sandwich part(s) of the sides of the intermediate insulation block and/or multiple parts of the sides of the intermediate insulation block sandwich the end(s) of the insulation sheet(s). This helps to increase the path length around the edges of the intermediate insulation block and the ends of the insulation sheet(s), which thus helps to reduce the risk of surface tracking along this path between the power transmission plates.

Preferably the one or more slots (e.g. each) extend in a (e.g. radial) direction across the walls of the vacuum chamber (i.e. between the interior and the exterior of the vacuum chamber). Thus, preferably the one or more slots formed on the interior side of the intermediate insulation block preferably extend in a direction towards the interior of the vacuum chamber. Preferably the one or more slots formed on the exterior side of the intermediate insulation block preferably extend in a direction towards the exterior of the vacuum chamber. When the intermediate insulation block comprises a plurality of slots, preferably the slots extend in respective parallel directions.

The intermediate insulation block may comprise any suitable and desired number of slots on each side. Preferably the intermediate insulation block comprises the same number of slots on the interior side as on the exterior side. The number of slots provided in (e.g. each side of) the intermediate insulation block may be a trade-off between the depth and number of the slots (and thus the set(s) of insulation sheet(s)), e.g. in order to increase the path length around the edges of the intermediate insulation block and the insulation sheet(s). Preferably the intermediate insulation block comprises at least two (e.g. three) slots formed in the first side. Preferably the intermediate insulation block comprises at least two (e.g. three) slots formed in the second side. When the intermediate insulation block comprises a plurality of slots formed in the first and/or second sides, preferably the slots (e.g. on the first and/or second sides) have substantially the same depth into the intermediate insulation block.

In one embodiment the intermediate insulation block comprises one or more slots formed in one or more edges of the first side and/or one or more slots formed in one or more edges of the second side. Preferably the edges of the first side and the second side of the intermediate insulation block (e.g. each) are adjacent to (and, e.g., face) the first and second power transmission plates respectively. Thus, preferably the one or more insulation sheets arranged in these edge slots are sandwiched (e.g. clamped) between the intermediate insulation block and the respective power transmission plate. It will thus be appreciated that preferably the edge slots are adjacent to (e.g. arranged either side of) the mating surfaces of the intermediate insulation block.

Preferably the one or more edge slots are formed as a step or taper in the intermediate insulation block. Providing a step may help to form a stop in the edge slots for the insulation sheet(s) to abut. Preferably the edge slots extend from the mating surfaces of the intermediate insulation block.

Preferably the mating surface(s) of the intermediate insulation block (e.g. each) have a dimension in a (e.g. radial) direction across the walls of the vacuum chamber that is substantially equal to the dimension in a (e.g. radial) direction across the walls of the vacuum chamber of the mating surface of the adjacent outer insulation block. Thus preferably the dimension of the intermediate insulation block (e.g. including the part(s) in which the one or more slots are formed) in a (e.g. radial) direction across the walls of the vacuum chamber is greater than the dimension of the first and/or second insulation blocks in a (e.g. radial) direction across the walls of the vacuum chamber.

In one embodiment the intermediate insulation block comprises one or more slots formed away from the edges (e.g. in a central region) of the first side and/or the second side. In this embodiment, these central slot(s) have parts of the intermediate insulation block on each side of the slot(s). Thus, preferably the one or more insulation sheets arranged in these central slot(s) are sandwiched (e.g. clamped) between (e.g. projecting) parts of the intermediate insulation block.

It will be appreciated that the intermediate insulation block may comprise any suitable and desired arrangement of slots, e.g. of edge slot(s) and/or central slot(s). However, in a preferred embodiment the intermediate insulation block comprises two slots formed in the two edges of the first side (i.e. adjacent to the power transmission plates), a central slot formed in the first side, two slots formed in the two edges of the second side (i.e. adjacent to the power transmission plates), and a central slot formed in the second side.

The intermediate insulation block may be formed as a single, integral piece of material. However, in some embodiments, e.g. when the intermediate insulation block comprises a plurality of slots in (e.g. each of) the first and second sides, the intermediate insulation block comprises a plurality of sub-blocks, wherein at least one of the one or more (e.g. plurality of) (e.g. central) slots are formed between (e.g. each of) the plurality of sub-blocks, e.g. when the plurality of sub-blocks are placed together.

Forming the intermediate insulation block from two or more sub-blocks may help to manufacture the intermediate insulation block. This is because it may not be necessary to form the slot(s) away from the edges of the intermediate insulation block as cavities in the intermediate insulation block (i.e. with the slot(s) surrounded on both sides), owing to these slot(s) being formed between the sub-blocks. It will be appreciated that if the intermediate insulation block were to have one or more slots formed away from its edges as cavities, this may be difficult to form as a single block, owing to the physical geometry (in at least preferred embodiments) of the (e.g. relatively large radius and thin) projecting parts of the intermediate insulation block between or to the side of the one or more slots. Thus, preferably one or more (e.g. each) of the sub-blocks comprise one or more slots formed in one or more edges of the first side of the sub-blocks and/or one or more slots formed in one or more edges of the second side of the sub-blocks.

Preferably the (e.g. each of the) sub-blocks comprise (internal) mating surfaces for sealing against another of the sub-blocks. Thus, preferably two sub-blocks comprise respective (internal) mating surfaces that seal against each other (as well, for example, as the (external) mating surface for sealing against the power transmission plate). In one embodiment one or more (e.g. any combination or all) of the mating surfaces of (e.g. each of) the sub-blocks comprise one or more grooves, wherein a compressible material is arranged in (e.g. each of) the grooves. Preferably the compressible material comprises a gasket, e.g. a linear cord or an O-ring. Preferably the grooves of adjacent mating surfaces of the sub-blocks are offset from each other (e.g. in the manner outlined above for the insulation blocks).

The one or more (e.g. central) slots away from the edges of the intermediate block may have any suitable and desired shape. As with the edge slots, the central slots may be stepped (e.g. rectangular). However, in a preferred embodiment the central slots are tapered (e.g. widening towards the opening of the slots at the face of the first or second side, as appropriate). This helps to insert the one or more insulation sheets into the slots (e.g. owing to the wider opening) and helps to retain the insulation sheet(s) in the slots (e.g. owing to the narrower end of the slots). The tapering slots also help to reduce the thickness of material of the intermediate insulation block towards the sides of the intermediate insulation block. This helps to increase the bulk insulation of the seal where the insulation sheet(s) end and the risk of dielectric breakdown may be increased.

The one or more slots (and thus the overlap between the intermediate insulation block and the one or more insulation sheets) may have any suitable and desired depth (e.g. in a direction towards the interior or exterior (as appropriate) of the vacuum chamber). In one embodiment the one or more slots have a depth greater than 5 cm, e.g. greater than 8 cm, e.g. approximately 10 cm. The depth of the one or more slots is preferably greater than tracking distance which the seal is defending against. When there are fewer slots, the one or more slots may have a greater depth. When there are greater slots, the slots may be able to have a lesser depth.

The one or more (interior and exterior) insulation sheets may be provided in any suitable way in the one or more slots of the intermediate insulation block. Preferably the seal comprises the same number of sets of one or more insulation sheets as the number of slots in the intermediate insulation block, such that there are one or more insulation sheets extending from each of the one or more slots. Thus, preferably the seal comprises at least two (e.g. three) sets of one or more interior insulation sheets for extending between the first and second power transmission plates on the interior of the vacuum chamber, wherein the at least two (e.g. three) sets of one or more interior insulation sheets are arranged in the at least two (e.g. three) sets of slots in the first side of the intermediate insulation block.

Similarly, preferably the seal comprises at least two (e.g. three) sets of one or more exterior insulation sheets for extending between the first and second power transmission plates on the exterior of the vacuum chamber, wherein the at least two (e.g. three) sets of one or more exterior insulation sheets are arranged in the at least two (e.g. three) sets of slots in the second side of the intermediate insulation block. As with the multiple slots on (e.g. each side of) the intermediate insulation block, providing multiple sets of insulation sheets helps to increase the insulation between the power transmission plates and helps to increase the path length between them, which reduces the risk of surface tracking between the plates.

In a preferred embodiment the seal comprises a plurality of insulation sheets in (e.g. each of) the one or more slots of the intermediate insulation block. The plurality of insulation sheets in (e.g. each) set of insulation sheets preferably comprises at least ten insulation sheets, e.g. at least fifteen insulation sheets, e.g. at least twenty insulation sheets. Providing multiple sheets in each set of insulation sheets helps to increase the amount of insulation between the power transmission plates. Preferably the plurality of insulation sheets are distributed equally between the one or more slots of the intermediate insulation block.

The (interior and exterior) insulation sheets may have any suitable and desired geometry. Preferably (e.g. each of) the one or more insulation sheets have a thickness (in a direction (e.g. parallel to the direction) between the first and second walls of the vacuum chamber) less than 200 microns, e.g. less than 100 microns, e.g. approximately 75 microns. A greater number of thinner sheets offers greater protection against electrical breakdown. Thinner sheets are, however, more susceptible to mechanical damage, so a balance between the number of sheets and their thickness may be provided to achieve a particular dielectric strength.

Preferably the (interior and exterior) insulation sheets extend from the slot(s) of the intermediate insulation block into the (interior and exterior of the) vacuum chamber between the power transmission plates over a significantly greater distance than the depth of the slot(s) of the intermediate insulation block. This means that the insulation sheets provide the significant majority of the insulation between the power transmission plates, which helps to reduce the inductance between the power transmission plates.

When the seal extends around the perimeter of the vacuum chamber, e.g. such that the insulation sheets extend around the perimeter of the vacuum chamber, each insulation sheet may extend continuously around the perimeter. However, in a preferred embodiment, the seal comprises a plurality of overlapping insulation sheets arranged in (e.g. each of) the one or more slots, wherein each of the insulation sheets of the plurality of overlapping insulation sheets extends around less than the perimeter of the vacuum chamber and at least one (e.g. an adjacent one) of the plurality of overlapping insulation sheets extends around a portion of the perimeter that is common with at least another of the plurality of overlapping insulation sheets. Such overlapping insulation sheets may comprise overlapping interior insulation sheets and/or overlapping exterior insulation sheets.

The plurality of overlapping insulation sheets may be arranged in any suitable and desired configuration. In a preferred embodiment each of the insulation sheets of the plurality of overlapping insulation sheets extends around half of the perimeter of the vacuum chamber. Preferably (e.g. each pair of) adjacent insulation sheets in the plurality of overlapping insulation sheets overlap over approximately a sixth of the perimeter of the vacuum chamber, e.g. over an angle (e.g. subtended about the centre of the vacuum chamber) of approximately 60 degrees around the perimeter of the vacuum chamber. Thus, preferably three adjacent insulation sheets are arranged (e.g. equally spaced) around the perimeter of the vacuum chamber to provide two overlapping layers of insulation sheets.

The interior and exterior insulation sheet(s) may be made from any suitable and desired (dielectric) material, e.g. a thin film. In a preferred embodiment the interior and exterior insulation sheet(s) are made from a polyester, e.g. biaxially-oriented polyethylene terephthalate (boPET) such as Mylar (RTM).

The (e.g. components of the) seal may be arranged to provide any suitable and desired (e.g. reduced, e.g. minimised) inductance. In one embodiment the seal has an inductance of less than 10 nH, e.g. less than 5 nH, e.g. less than 3 nH. Such values of the inductance of the seal helps a high voltage with a fast discharge to be delivered to (e.g. a load in) the vacuum chamber by the power transmission plates.

### BRIEF DESCRIPTION OF DRAWINGS

A preferred embodiment for the invention will now be described, by way of example only, with reference to the accompanying drawings in which:

FIG. 1 shows schematically a pulsed power apparatus according to an embodiment of the present invention;

FIG. 2 shows a cross section of an electric power feed apparatus according to an embodiment of the present invention; and

FIG. 3 shows a set of insulation sheets, in accordance with an embodiment of the present invention, for use in the electric power feed apparatus shown in FIG. 2.

### DETAILED DESCRIPTION

An embodiment of the invention, which provides a vacuum chamber for use in a pulsed power (e.g. high energy density physics) apparatus will now be described. Such a pulsed power apparatus requires a high voltage power supply to be fed into a vacuum chamber, for delivering a high voltage pulse to a load in the vacuum chamber. In order to maintain an effective vacuum in the vacuum chamber, a good seal around where the power supply enters the vacuum chamber needs to be provided. An effective vacuum helps to reduce the risk of electrical breakdown in the vacuum chamber. As will be described, the seal according to an embodiment of the present invention helps to minimise the inductance that results from the insulation of the seal between the power transmission plates of the power supply.

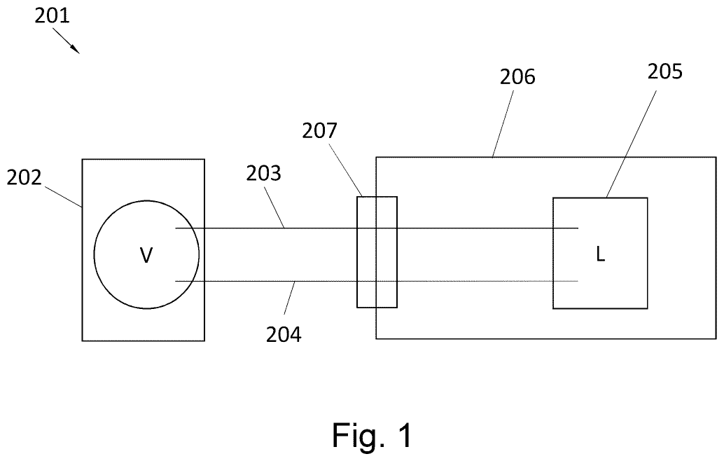

FIG. 1 shows a pulsed power apparatus 201 according to an embodiment of the present invention. The pulsed power apparatus 201 includes a voltage generation system 202 that is arranged to apply a voltage, V, between a pair of power transmission plates 203, 204. The power transmission plates 203, 204 are arranged to deliver the voltage to a load 205 in a vacuum chamber 206. The vacuum chamber 206 has a seal 207 where the power transmission plates 203, 204 pass through the walls of the vacuum chamber 206.

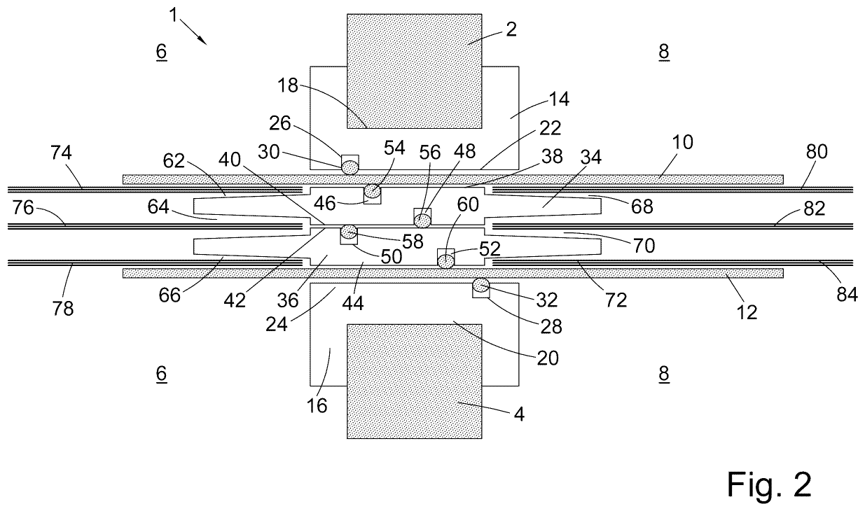

FIG. 2 shows an electric power feed apparatus 1 for a vacuum chamber according to an embodiment of the present invention, e.g. for use in the pulsed power apparatus 201 shown in FIG. 1. FIG. 2 shows a cross section through the walls 2, 4 of a vacuum chamber, which, with the electric power feed apparatus 1, extend around the perimeter of the vacuum chamber. The walls 2, 4 of the vacuum chamber thus define the boundary between the interior 6 and the exterior 8 of the vacuum chamber.

The electric power feed apparatus 1 includes a seal for sealing the gap between the walls 2, 4 of the vacuum chamber, through which a pair of electric power transmission plates 10, 12 passes. The power transmission plates 10, 12 are arranged to deliver a high voltage to a load inside the vacuum chamber.

The electric power feed apparatus 1 includes two U-shaped outer insulation blocks 14, 16 that fit around the edges of the walls 2, 4 of the vacuum chamber. The outer insulation blocks 14, 16 each have a planar mating surface 18, 20 that seals against the respective edge of the walls 2, 4 of the vacuum chamber. The outer insulation blocks 14, 16 also each have a planar mating surface 22, 24 that seals against the respective power transmission plates 10, 12. A groove 26, 28 is defined in each of the planar mating surfaces 22, 24 that face the power transmission plates 10, 12 and an O-ring 30, 32 is located in each groove 26, 28.

An intermediate insulation block, formed from two sub-blocks 34, 36, is sandwiched between the two power transmission plates 10, 12. Each sub-block 34, 36 has a planar mating surface 38, 40, 42, 44 on either side, the outer mating surfaces 38, 44 for sealing against the power transmission plates 10, 12, the inner mating surfaces 40, 42 for sealing against each other. A groove 46, 48, 50, 52 is defined in each mating surface 38, 40, 42, 44 and an O-ring 54, 56, 58, 60 is located in each groove 46, 48, 50, 52. As can be seen from FIG. 2, the grooves 26, 28, 46, 48, 50, 52 (and thus the O-rings 30, 32, 54, 56, 58, 60) are offset from each other in the mating surfaces 22, 24, 38, 40, 42, 44 that are adjacent to each other.

The sub-blocks 34, 36 of the intermediate insulation block extend further out than the outer insulation blocks 14, 16, with the edges of the sub-blocks 34, 36 being tapered. This tapering of the sub-blocks 34, 36 forms three slots 62, 64, 66, 68, 70, 72 on either side of the intermediate insulation block. A set of 20 Mylar (RTM) insulation sheets 74, 76, 78, 80, 82, 84 are located in each of the slots 62, 64, 66, 68, 70, 72, such that three sets of insulation sheets 74, 76, 78, extend into the interior 6 of the vacuum chamber and three sets of insulation sheets 80, 82, 84 extend to the exterior 8 of the vacuum chamber between the power transmission plates 10, 12.

In the interior 6 of the vacuum chamber, the power transmission plates 10, 12 are brought closer together than their spacing at the walls 2, 4 of the vacuum chamber and extend to a load (not shown) at the centre of the vacuum chamber. At the exterior 8 of the vacuum chamber, the power transmission plates 10, 12 are brought closer together than their spacing at the walls 2, 4 of the vacuum chamber and extend to a voltage generation system (e.g. as shown in FIG. 1) for charging the power transmission plates 10, 12 to a high voltage.

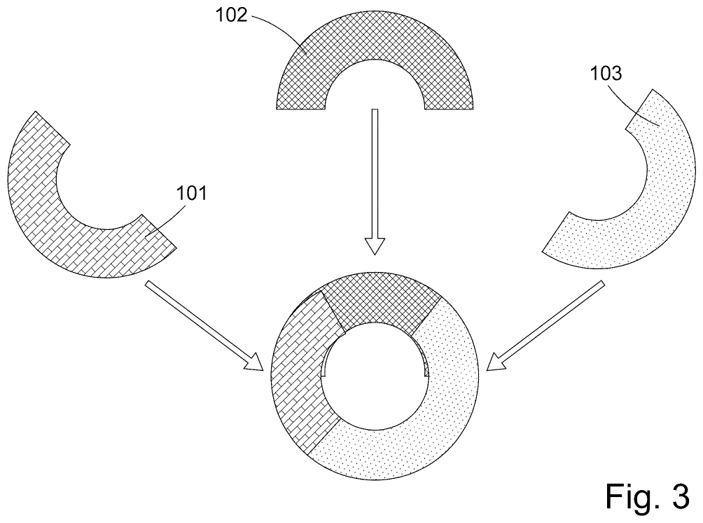

FIG. 3 shows a configuration of a set of insulation sheets, in accordance with an embodiment of the present invention, for use in the electric power feed apparatus 1 shown in FIG. 2. The insulation sheets 101, 102, 103 shown in FIG. 3 may form any one of the sets of insulation sheets 74, 76, 78, 80, 82, 84 in the electric power feed apparatus 1 shown in FIG. 2. Thus, each layer in the sets of insulation sheets 74, 76, 78, 80, 82, 84 (of which there may be twenty layers, for example) may be made up of three insulation sheets 101, 102, 103.

FIG. 3 shows that the insulation sheets 101, 102, 103 each extend around half of the perimeter of the vacuum chamber. The insulation sheets 101, 102, 103 in the set each overlap the adjacent insulation sheet by approximately 60 degrees.

In operation, the vacuum chamber and the electric power feed apparatus is assembled as shown in FIGS. 1 and 2. The power transmission plates 10, 12 are charged to a high voltage (e.g. ±100 kV) by a voltage generation system connected to the power transmission plates 10, 12. The seal between the power transmission plates 10, 12 and between the walls 2, 4 of the vacuum chamber act to insulate the power transmission plates 10, 12 from each other and from the walls 2, 4 of the vacuum chamber. This helps to allow the power transmission plates 10, 12 to be charged to the high voltage and to be kept at the high voltage without the risk of electrical breakdown. The high voltage is then discharged to the load in the vacuum chamber, e.g. as part of the pulsed power system shown in FIG. 1.

It will be seen from the above that, in at least preferred embodiments, the vacuum chamber seal of the present invention provides an effective seal between the walls of the vacuum and the pair of power transmission plates, owing to the solid insulation blocks. The insulation sheets of the seal help to allow the pair of power transmission plates to be brought closer together, thus helping to reduce the inductance between the pair of power transmission plates, while still providing sufficient insulation between them, e.g. to protect against electrical punch through, even when subject to a high electric field gradient. Thus, the seal of the present invention exploits the beneficial properties of both the insulation blocks (i.e. a good seal) and the insulation plates (i.e. low inductance).

The transition between the insulation sheets and the insulation blocks, via the slots, helps to reduce the extent of the insulation blocks, which also helps to reduce the inductance between the pair of power transmission plates, while still allowing a good seal to be provided and insulating the power transmission plates from each other. This helps to allow the power transmission plates to deliver a high voltage and current into the load in the vacuum chamber at a high discharge rate. The slots in the intermediate insulation block also help to increase the path length between the power transmission plates. This helps to reduce the risk of electrical breakdown owing to surface tracking.

The invention claimed is:

1. A seal for a vacuum chamber, wherein the vacuum chamber comprises a first wall and a second wall, the seal comprising:
a first outer insulation block for sealing between the first wall of the vacuum chamber and a first power transmission plate that extends from an interior of the vacuum chamber to an exterior of the vacuum chamber between the first and second walls of the vacuum chamber;
a second outer insulation block for sealing between the second wall of the vacuum chamber and a second power transmission plate that extends from the interior of the vacuum chamber to the exterior of the vacuum chamber between the first and second walls of the vacuum chamber;
an intermediate insulation block for sealing between the first and second power transmission plates, wherein the intermediate insulation block comprises a first slot formed in a first side of the intermediate insulation block for facing the exterior of the vacuum chamber; and
an exterior insulation sheet for extending between the first and second power transmission plates on the exterior of the vacuum chamber, wherein the exterior insulation sheet is arranged in the first slot in the first side of the intermediate insulation block.

2. The seal as claimed in claim 1, wherein the first and second power transmission plates are arranged to deliver a high voltage and/or a high current to a load in the vacuum chamber.

3. The seal as claimed in claim 1, wherein the first outer insulation block comprises mating surfaces for sealing against the first wall of the vacuum chamber and the first power transmission plate, wherein the second outer insulation block comprises mating surfaces for sealing against the second wall of the vacuum chamber and the second power transmission plate, and wherein the intermediate insulation block comprises mating surfaces for sealing against the first and second power transmission plates, and wherein the mating surfaces of each of the insulation blocks comprises one or more grooves, wherein a compressible material is arranged in each of the grooves, wherein the grooves in the mating surfaces are offset from each other.

4. A seal for a vacuum chamber as claimed in claim 1, wherein the intermediate insulation block comprises a second slot formed in a second side of the intermediate insulation block for facing the interior of the vacuum chamber; and
an interior insulation sheet for extending between the first and second power transmission plates on the interior of the vacuum chamber, wherein the interior insulation sheet is arranged in the second slot in the second side of the intermediate insulation block.

5. The seal as claimed in claim 3, wherein the mating surfaces of the intermediate insulation block have a dimension in a direction across the walls of the vacuum chamber that is substantially equal to the dimension in a direction across the walls of the vacuum chamber of the mating surface of the adjacent outer insulation block.

6. The seal as claimed in claim 1, wherein the dimension of the first and second outer insulation blocks, and the intermediate insulation block, in a direction across the walls of the vacuum chamber, is greater than or equal to the dimension of the first and second walls of the vacuum chamber in a direction across the walls of the vacuum chamber.

7. The seal as claimed in claim 1, wherein the dimension of the intermediate insulation block in a direction between the first and second walls of the vacuum chamber is greater than the ratio of the voltage across the power transmission plates to the dielectric strength of the intermediate insulation block.

8. The seal as claimed in claim 1, wherein the first and second outer insulation blocks are shaped to extend up the sides of the first and second walls of the vacuum chamber respectively.

9. The seal as claimed in claim 1, wherein the intermediate insulation block comprises at least two first slots formed in the first side of the intermediate insulation block.

10. The seal as claimed in claim 1, wherein the first slot comprises an edge slot formed in an edges of the first side of the intermediate insulation block adjacent to the first power transmission plate.

11. The seal as claimed in claim 10, wherein the edge slot is formed as a step or taper in the intermediate insulation block.

12. The seal as claimed in claim 1, wherein the first slot comprises a central slot formed away from the edges of the first side of the intermediate insulation block.

13. The seal as claimed in claim 1, wherein the intermediate insulation block comprises a plurality of sub-blocks, wherein the first slot is formed between the plurality of sub-blocks.

14. The seal as claimed in claim 13, wherein one or more of the sub-blocks comprise a first sub-block slot formed in an edge of the first side of the sub-blocks and/or a second sub-block slot formed in an edge of the second side of the sub-blocks.

15. The seal as claimed in claim 13, wherein the sub-blocks comprise mating surfaces for sealing against another of the sub-blocks, wherein one or more of the mating surfaces of the sub-blocks comprise a groove, wherein a compressible material is arranged in the groove.

16. The seal as claimed in claim 1, wherein the seal comprises a plurality of insulation sheets in the first slot of the intermediate insulation block.

17. The seal as claimed in claim 1, wherein the seal comprises a plurality of overlapping insulation sheets arranged in the first slot, wherein each of the insulation sheets of the plurality of overlapping insulation sheets extends around less than the perimeter of the vacuum chamber and at least one of the plurality of overlapping insulation sheets extends around a portion of the perimeter that is common with at least another of the plurality of overlapping insulation sheets.

18. A vacuum chamber comprising:
a first wall and a second wall defining the outer surface of the vacuum chamber;
a load within the vacuum chamber;
a first power transmission plate that extends from an interior of the vacuum chamber to an exterior of the vacuum chamber between the first and second walls of the vacuum chamber;
a second power transmission plate that extends from the interior of the vacuum chamber to the exterior of the vacuum chamber between the first and second walls of the vacuum chamber, wherein the first and second power transmission plates are arranged to deliver a voltage to the load; and
a seal for sealing between the first and second walls, and between the first and second power transmission plates;
wherein the seal comprises:
a first outer insulation block sealing between the first wall of the vacuum chamber and the first power transmission plate;
a second outer insulation block sealing between the second wall of the vacuum chamber and the second power transmission plate;
an intermediate insulation block sealing between the first and second power transmission plates, wherein the intermediate insulation block comprises a first slot formed in a first side of the intermediate insulation block facing the exterior of the vacuum chamber; and
an exterior insulation sheet extending between the first and second power transmission plates on the exterior of the vacuum chamber, wherein the exterior insulation sheet is arranged in the first slot in the first side of the intermediate insulation block.

19. An electric power feed apparatus for delivering a voltage to a load within a vacuum chamber, wherein the vacuum chamber comprises a first wall and a second wall, the electric power feed apparatus comprising:
a first power transmission plate for extending from an interior of the vacuum chamber to an exterior of the vacuum chamber between the first and second walls of the vacuum chamber;
a second power transmission plate for extending from the interior of the vacuum chamber to the exterior of the vacuum chamber between the first and second walls of the vacuum chamber, wherein the first and second power transmission plates are arranged to deliver the voltage to the load; and
a seal for sealing between the first and second walls, and between the first and second power transmission plates, wherein the seal comprises:
a first outer insulation block for sealing between the first wall of the vacuum chamber and the first power transmission plate;
a second outer insulation block for sealing between the second wall of the vacuum chamber and the second power transmission plate;
an intermediate insulation block sealing between the first and second power transmission plates, wherein the intermediate insulation block comprises a first slot formed in a first side of the intermediate insulation block for facing the exterior of the vacuum chamber; and
an exterior insulation sheet extending between the first and second power transmission plates on the exterior of the vacuum chamber, wherein the exterior insulation sheet is arranged in the first slot in the first side of the intermediate insulation block.

20. A pulsed power apparatus comprising:
a vacuum chamber, the vacuum chamber comprising:
a first wall and a second wall defining the outer surface of the vacuum chamber; and
a load within the vacuum chamber;
the pulsed power apparatus further comprising:
a first power transmission plate that extends from an interior of the vacuum chamber to an exterior of the vacuum chamber between the first and second walls of the vacuum chamber;
a second power transmission plate that extends from the interior of the vacuum chamber to the exterior of the vacuum chamber between the first and second walls of the vacuum chamber, wherein the first and second power transmission plates are arranged to deliver a voltage to the load;
a voltage generation system for applying a voltage between the first and second power transmission plates; and
a seal for sealing between the first and second walls, and between the first and second power transmission plates;
wherein the seal comprises:
a first outer insulation block sealing between the first wall of the vacuum chamber and the first power transmission plate;
a second outer insulation block sealing between the second wall of the vacuum chamber and the second power transmission plate;
an intermediate insulation block sealing between the first and second power transmission plates, wherein the intermediate insulation block comprises a first slot formed in a first side of the intermediate insulation block facing the exterior of the vacuum chamber; and
an exterior insulation sheet extending between the first and second power transmission plates on the exterior of the vacuum chamber, wherein the exterior insulation sheet is arranged in the first slot in the first side of the intermediate insulation block.
